(19) United States
(12) Patent Application Publication
(10) Pub. No.: US 2025/0378731 A1
(43) Pub. Date: Dec. 11, 2025

(54) INTERACTIVE BINGO GAMING SYSTEMS, METHODS, AND DEVICES AND VARIATIONS

(71) Applicant: CASTLE ISLAND IP HOLDING LLC, Charlottesville, VA (US)

(72) Inventors: Alan ROIREAU, Charlottesville, VA (US); Joshua LARSON, Charlottesville, VA (US); Daniel FULTON, Charlottesville, VA (US); Thomas ZAHORIK, Charlottesville, VA (US); Paul SUGGS, Charlottesville, VA (US)

(21) Appl. No.: 19/228,507

(22) Filed: Jun. 4, 2025

Related U.S. Application Data
(60) Provisional application No. 63/656,937, filed on Jun. 6, 2024.

(51) Int. Cl. G07F 17/32

(52) U.S. Cl. CPC G07F 17/3202

(57) ABSTRACT

Systems, methods, and devices for immersive, interactive games of Bingo and variations are provided. When calls are made in a Bingo game that is transmitted electronically to one or more distributed computing devices, a daub is placed on a card in a space that has the correct indicator. The daub can be displayed with various colors, shapes, and animations to increase the appeal and excitement of the Bingo game. Some daubs have different values which can be assigned at random, and a winning Bingo card can result in a payout proportional to the value of the daubs. Some daubs are able to apply to more than one space on the Bingo card. With some daubs, players have the ability to make a choice that can affect placement of the daub or daubs and can result in a higher payout in the event of a win.

### FIELD OF THE DISCLOSURE

The present disclosure is directed generally to interactive, immersive wagering games such as Bingo and variations thereof. There is an increasing demand for exciting, interactive wagering games.

### BACKGROUND

Bingo is a well-known game that has been played using paper cards and physical daubs such as beans, coins, candies, or other common items. Electronic Bingo has become a popular game providing users a wagering opportunity.

Within the gambling or gaming industry, including sports betting, esports betting, games of chance, etc., traditional gaming machines include slot machines, poker machines, video lottery terminals, gaming consoles, and similar devices. These traditional gaming machines are configured to provide an interface for wagering on game events and have proven popularity. However, players quickly become tired of various adaptations of existing gaming machines, requiring the development of new and inventive ways to represent or play games on such gaming machines. For this reason, game creators must continually invent new and innovative ways to represent games and gameplay to stimulate players and encourage further interest.

Gaming in the United States is generally categorized into class I, class II and class III for the purposes of regulation, with class I gaming being defined as traditional tribal gaming subject to the least regulation, and class III gaming being subject to the greatest regulation and broadly encompassing all forms of gaming that are neither class I or II (e.g. casino or table games such as slot machines, blackjack, craps, roulette, etc.).

Class II gaming includes the game commonly referred to as bingo, whether or not electronic, computer, or other technological aids are used in connection with the game. In traditional bingo, players purchase cards that include different arrangements of tokens, such as numbers or other symbols, in a grid or other pattern. A caller randomly selects tokens from a token pool and players match the called tokens to their cards. When the matched tokens on a player's card form certain predetermined patterns or arrangements, such as a line, only corners, a completely filled card or other arrangement, the card may be identified as a winning card and scored accordingly, such that a corresponding reward or prize may be disbursed. A number of winning arrangements may be possible, such that a winning card may or may not conclude the game.

### SUMMARY

The inventors of the present application have identified a need to maintain and keep the interest of electronic Bingo players. An object of the present disclosure is to provide more elaborate, interactive, and immersive variations of Bingo to be played at electronic gameplay stations, wagering terminals, and gaming servers, including gaming consoles, gaming machines or networked gaming machines, such as gameplay stations, wagering terminals, and gaming servers found in casinos or betting environments, and related methods of operation.

Embodiments of the present disclosure are directed to a gaming system including a display device configured to display an output to a user pertaining to a Bingo game, and an input device configured to accept a wager on one or more outcomes of the Bingo game, and to accept one or more control inputs from a user pertaining to the Bingo game. The gaming system also includes a processor and a memory configured to store and execute a method. The method includes presenting to the user a Bingo card having a plurality of spaces in a grid, wherein each space has an associated identifier and a location on the card, wherein the identifiers are assigned at random, and executing a series of calls, each call including an identifier selected at random and a daub selected at random. The method also includes selecting a daub for each call wherein the daub is displayed on the display device on the card in a space corresponding to the identifier in the call, and for each call, the daub is randomly assigned a display characteristic, a value characteristic, a location characteristic. The method also includes identifying a combination of daubs relative to the card that satisfies one or more winning conditions and awarding to the user a payout according to the one or more winning conditions and the wager.

Further embodiments of the present disclosure are directed to a gaming system including a display device configured to display an output to a user pertaining to a Bingo game and an input device configured to accept a wager on one or more outcomes of the Bingo game, and to accept one or more control inputs from a user pertaining to the Bingo game. The gaming system can also execute a method including presenting to the user a first Bingo card having a plurality of first spaces in a grid, and presenting to the user a second Bingo card having a plurality of second spaces in a grid. The first spaces align with the second spaces. The method also includes executing a series of calls for the first Bingo card, each call including an identifier selected at random pertaining to a first space on the first Bingo card resulting in a first daub placed on the first space. The first daub is applied to a second space on the second Bingo card as a second daub according to one or more predetermined conditions.

Still further embodiments of the present disclosure are directed to a gaming system including a display device configured to display an output to a user pertaining to a Bingo game and an input device configured to accept a wager on one or more outcomes of the Bingo game and to accept one or more control inputs from a user pertaining to the Bingo game. The gaming system can present to the user two or more Bingo cards each having a plurality of spaces in a grid. Each space has an associated identifier and a location on the card, wherein the identifiers are assigned at random. The Bingo cards include first spaces and second spaces visually distinct from the first spaces. Arranging two or more Bingo cards relative to one another forms an image combining first spaces from one Bingo card and first spaces from a second Bingo card. A winning combination of calls pertains to the image.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 depicts a conventional gaming machine having a support structure, housing, or cabinet which provides support for a plurality of displays, inputs, controls, and other features of a conventional gaming machine;

FIG. 2A illustrates an electronic system for facilitating gaming by a player according to the present disclosure;

FIG. 2B illustrates a gaming system according to the present disclosure;

FIG. 3 illustrates an embodiment of a gaming system comprising a processor and a memory for operating a corresponding entertaining display and a corresponding user interface according to embodiments of the present disclosure.

FIGS. 4A, 4B, 4C, 4D, 4E, and 4F are illustrations of a Bingo cards of embodiments of Bingo games according to embodiments of the present disclosure.

FIG. 5 is an illustration of a variation of a Bingo game including wildcard daubs according to embodiments of the present disclosure.

FIGS. 6A and 6B illustrates further embodiments of Bingo games with an additional card according to embodiments of the present disclosure.

FIG. 7 is an illustration of a Bingo game and variations including daubs of differing values according to embodiments of the present disclosure.

FIG. 8 illustrates a Bingo game and variations having layered cards according to embodiments of the present disclosure.

FIG. 9 is an illustration of a Bingo game and variations having alternate free space patterns according to embodiments of the present disclosure.

FIG. 10 is another illustration of a Bingo game including movable daubs are applied according to embodiments of the present disclosure.

FIG. 11 is another illustration of a Bingo game including anticipatory markers according to embodiments of the present disclosure.

FIG. 12 is another illustration of a Bingo game including variations with multiple cards that, when combined, form an image to complete a win according to embodiments of the present disclosure.

### DETAILED DESCRIPTION OF THE INVENTION

The present disclosure provides various examples and embodiments of wagering games such as Bingo games and accompanying game systems, methods, and related components. Such devices, systems, etc., may be played using personal electronic devices such as smart phones, tablets, laptops, etc. Other game environments can be housed in a dedicated gaming facility and the game is part of a cabinet or other installation that can be accessed by a user at the facility. Disclosed embodiments include variations and elaborations on the popular game Bingo.

### I. Introduction

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. The dimensions, angles, and curvatures represented in the figures introduced above are to be understood as exemplary and are not necessarily shown in proportion. It should be understood, however, there is no intention to limit the disclosure to the specific embodiments disclosed, but on the contrary, the intention covers all modifications, alternative constructions, combinations, and equivalents falling within the spirit and scope of the disclosure.

The flowchart illustrations and block diagrams in the flow diagrams illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s).

It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart illustrations and/or block diagram block or blocks.

The disclosed embodiments relate to systems and methods for gaming that overcome the problems of static gameplay in existing gaming machines and provide an improved experience for players. The disclosure outlines some example improvements and practical applications provided by the disclosed embodiments. These are just examples only and the embodiments are not limited to only these improvements.

As used in the present disclosure, a “local connection” or “local communications interface” is generally used to refer to a direct connection by means of a network, whether wired or wireless, or similar means that does not require or otherwise involve the use of an internet or other third-party data connection.

Examples of the current disclosure may be provided in terms referring to a bingo game, however there is no intention to limit the disclosure thereto. Rather, one of ordinary skill in the art will recognize the possibility of applying the same principles of embodiments of the current disclosure to alternative forms of gaming.

As referenced in the examples of the current disclosure, a “game,” “active game,” “existing game,” and/or “new game” may be used to refer to a bingo call or another set of parameters governing results of a wager. A player or gameplay request entering or being assigned to a game generally refers to applying the call associated with the game to a wager associated with the player or gameplay request.

Embodiments of a gaming system and related methods are provided for increasing the availability and variability of games in the gaming system by employing a gaming engine and an experience engine as distinct portions of the gaming system, while reducing the processing requirements of the gaming system and delays in gameplay. The use of the gaming engine and the entertainment engine may separate the result of the wager from the gameplay, enabling the gaming system to present a user with entertaining gameplay while streamlining the underlying wager. Further, regulatory constraints for operation of the gaming system are reduced, and locations suitable for providing a gaming system are increased without the associated costs and complexity of prior art systems.

The disclosed embodiments operate to improve how a gaming machine comprising a computing device operates and/or functions. Although the concepts described herein would be applicable and implemented in a Bingo-only game, that is a Bingo game that displays only as a Bingo game, the disclosed embodiments are able to be used and applied to increase the variety and variability of entertaining displays or secondary game types available for gaming by following the disclosed principles. Furthermore, the processing speed and operational efficiency of the gaming machine can be improved. As a consequence, the disclosed embodiments operate to improve the computing efficiency and resource utilization of a gaming machine and related computing architecture. As an additional example, by varying the entertaining display or secondary game type based on the reward values and the result of the player's wager, the disclosed embodiments will also improve the presentation of the game to a player.

The disclosed embodiments may be implemented in various configurations for gaming machines, gaming devices, or gaming systems, including but not limited to: (1) a dedicated gaming machine, gaming device, or gaming system wherein the computerized instructions for controlling any games (which are provided by the gaming machine or gaming device) are provided with the gaming machine or gaming device prior to delivery to a gaming establishment; and (2) a changeable gaming machine, gaming device, or gaming system wherein the computerized instructions for controlling any games (which are provided by the gaming machine or gaming device) are downloadable to the gaming machine or gaming device through a data network after the gaming machine or gaming device is in a gaming establishment.

In embodiments, the computerized instructions for controlling games may be executed by at least one central server, central controller, or remote host. In such a “thin client” embodiment, the central server remotely controls any games (or other suitable interfaces) and the gaming machine is utilized to display such games (or suitable interfaces) and receive one or more inputs or commands from a player. In another embodiment, the computerized instructions for controlling games may be communicated from the central server, central controller, or remote host to a gaming machine's local processor and memory devices. In such a “thick client” embodiment, the gaming machine's local processor executes the communicated computerized instructions to control any games (or other suitable interfaces) provided to a player.

### II. Gaming Machine and Gaming System

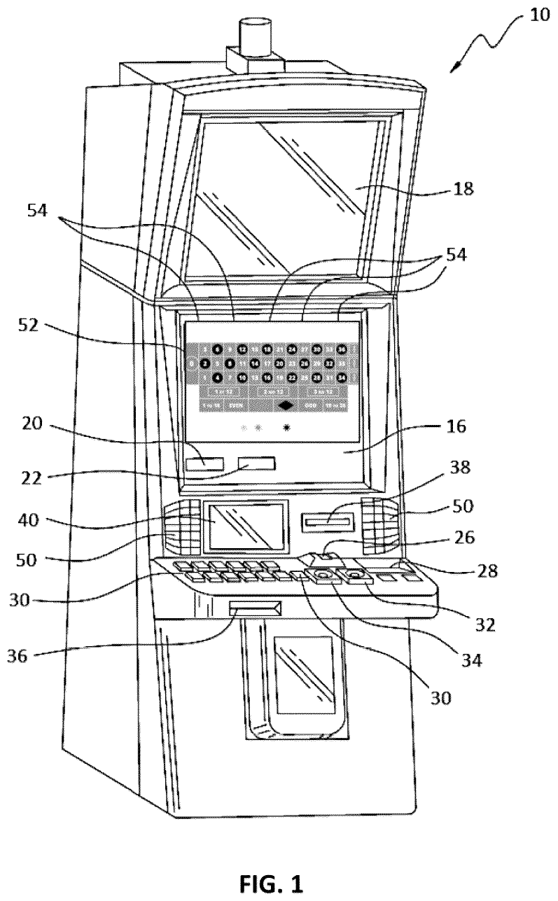

Referring to FIG. 1, one embodiment of a gaming machine 10, according to an embodiment of the present disclosure, has a support structure, housing, or cabinet which provides support for a plurality of displays, inputs, controls, and other features of a conventional gaming machine. It may be configured so that a player can operate it while standing or sitting. The gaming machine 10 can be positioned on a base or stand or can be configured as a pub-style table-top game (not shown) which a player can operate preferably while sitting. The gaming machine 10 may have varying cabinet and display configurations.

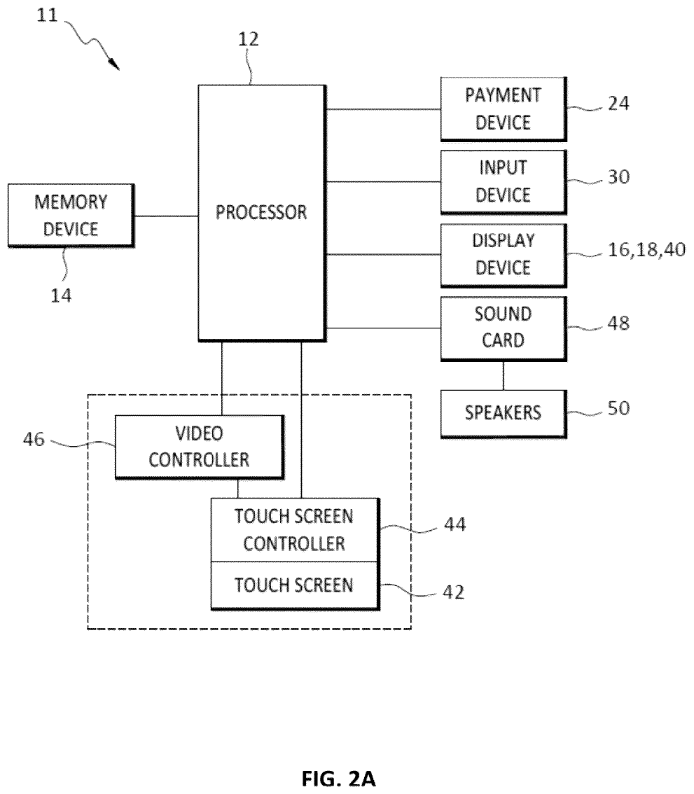

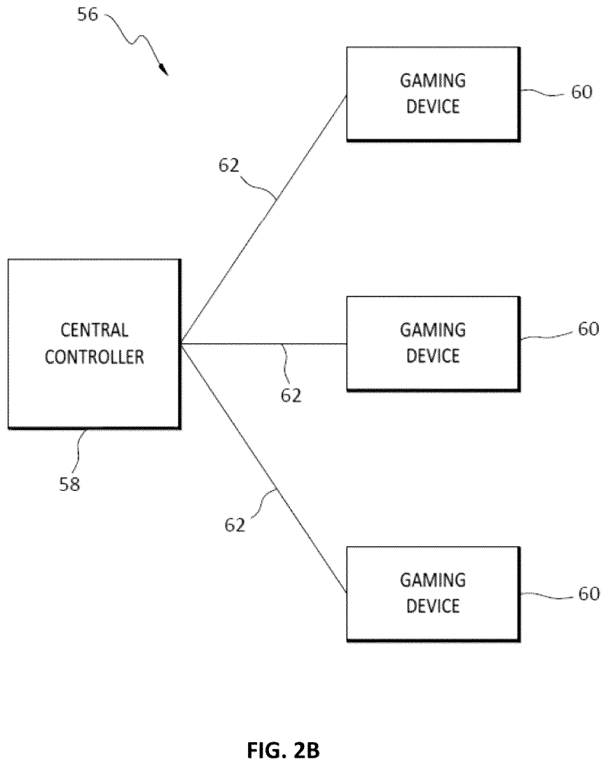

In one embodiment, as illustrated in FIG. 2A, an electronic system for facilitating gaming by a player according to the present disclosure is generally shown at 11. The electronic system 11 may be a separate gaming machine or used with the gaming machine 10 of FIG. 1. The electronic system 11 may include at least one processor 12, such as a microprocessor, a microcontroller-based platform, a suitable integrated circuit or one or more application-specific integrated circuits (ASIC's). The processor 12 may be in communication with or operable to access or to exchange signals with at least one data storage or memory device 14.

In an embodiment, the processor 12 and the memory device 14 may reside within the cabinet of the gaming machine 10. The memory device 14 may store program code and instructions, executable by the processor 12, to control the gaming machine 10. The memory device 14 may also store other data such as image data, player input data, random or pseudo-random number generators, pay-table data or information, and applicable game rules that relate to the play of the game. In an embodiment, the memory device 14 may include random access memory (RAM), which can include non-volatile RAM (NVRAM), magnetic RAM (MRAM), ferroelectric RAM (FeRAM), and other forms. In one embodiment, the memory device 14 may include read only memory (ROM). In one embodiment, the memory device 14 may include flash memory and/or EEPROM (electrically erasable programmable read only memory). Any other suitable magnetic, optical, and/or semiconductor memory may operate in conjunction with the electronic system 11.

In one embodiment, part or all of the program code and/or operating data described above may be stored in a detachable or removable memory device 14, including, but not limited to, a suitable cartridge, disk, CD ROM, DVD, or USB memory device. In other embodiments, part or all of the program code and/or operating data described above may be downloaded to the memory device 14 through a suitable network.

In one embodiment, an operator or a player can use such a removable memory device in a desktop computer, a laptop computer, a hand-held device, such as a personal digital assistant (PDA), a portable computing or mobile device, or another computerized platform to implement embodiments of the present disclosure. In one embodiment, the electronic system 11 is operable over a wireless network, for example as part of a wireless gaming machine. In one such embodiment, the electronic system 11 may be a hand-held device, a mobile device, or any other suitable wireless device that enables a player to play any suitable game at a variety of different locations.

In various embodiments in which the electronic system 11 may be a hand-held device, a mobile device, or any other suitable wireless device, at least one memory device 14 and at least one processor 12 which control the game or other operations of the hand-held device, mobile device, or other suitable wireless device may be located: (a) at the hand-held device, mobile device or other suitable wireless device; (b) at a central server or central controller; or (c) any suitable combination of the central server or central controller and the hand-held device, mobile device or other suitable wireless device. A gaming device or gaming machine as disclosed herein may be a device that has obtained approval from a regulatory gaming commission or a device that has not obtained approval from a regulatory gaming commission. The processor 12 and memory device 14 may be collectively referred to herein as a “computer,” “computing device” or “controller.”

In embodiments, as illustrated in FIG. 2A, the electronic system 11 may include one or more display devices 16, 18, 40 controlled by the processor 12. The display devices 16, 18, 40 may preferably be connected to or mounted on the cabinet of the gaming machine 10. The embodiment shown in FIG. 1 includes a central display device 16 which displays a primary or base game and an upper display device 18. The central display device 16 may also display any suitable secondary game associated with the primary or base game as well as information relating to the primary or secondary game. The upper display device 18 may display the primary game, any suitable secondary game associated or not associated with the primary game, and/or information relating to the primary or secondary game. These display devices 16, 18 may also serve as digital glass operable to advertise games or other aspects of the gaming establishment.

As seen in FIG. 1, in various embodiments, the gaming machine 10 may include a credit display 20 which displays a player's current number of credits, cash, account balance, or the equivalent. The gaming machine 10 may include a bet display 22 which displays a player's amount wagered. The gaming machine 10 may include a player tracking display 40 which displays information regarding a player's play status, such as including past wins, number of past wagers, etc. One or more of these display devices 16, 18, 20, 22, 40 may be in communication with the processor 12.

In another embodiment, at least one display device may be a mobile display device, such as a PDA or tablet PC, that enables play of at least a portion of the primary or secondary game at a location remote from the gaming machine 10 or electronic system 11.

The display devices 16, 18, 40 may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In one embodiment, as described in more detail below, the display devices 16, 18, 40 include a touch-screen with an associated touch-screen controller. The display devices 16, 18, 40 may be of any suitable size and configuration, such as a square, a rectangle or an elongated rectangle.

The display devices 16, 18, 40 of the gaming machine 10 may be configured to display at least one and preferably a plurality of games or other suitable images, symbols and indicia such as any visual representation or exhibition of the movement of objects such as mechanical and/or virtual.

In one embodiment, the symbols, images and indicia displayed on or of the display device may be in mechanical form. That is, the display devices 16, 18, 40 may include any electromechanical device, such as one or more mechanical objects. An example of an exemplary electromechanical device according to embodiments of the disclosure may include a roulette wheel, dice, cards, or the like, configured to display at least one or a plurality of games or other suitable images, symbols or indicia.

As illustrated in FIG. 2A, the electronic system 11 may include at least one payment device 24 in communication with the processor 12. The payment device 24 may be a payment acceptor including a note, ticket or bill acceptor 28 (FIG. 1) wherein the player inserts paper money, a ticket, or voucher, and/or a coin slot 26 (FIG. 1) where the player inserts money, coins, or tokens. In other embodiments, other payment devices 24 such as readers or validators for credit cards, debit cards or credit slips may accept payment. A player may insert an identification card into a card reader 24 of the gaming machine 10.

An identification card may be a smart card having a programmed microchip, a coded magnetic strip or coded rewritable magnetic strip, wherein the programmed microchip or magnetic strips are coded with a player's identification, credit totals (or related data), and/or other relevant information. In another embodiment, a player may carry a portable device, such as a cell phone, a radio frequency identification tag, or any other suitable wireless device, which communicates a player's identification, credit totals (or related data), and other relevant information to the gaming machine 10. In one embodiment, money may be transferred by a player to a gaming machine 10 through electronic funds transfer. When a player funds the gaming machine 10, the processor 12 may determine the amount of funds entered and display the corresponding amount on the credit or other suitable display as described previously.

As seen in FIGS. 1 and 2A, in an embodiment the gaming machine 10 and electronic system 11 may include at least one input device 30 in communication with the processor 12. The at least one input device 30 can include any suitable device which enables the player to produce an input signal which is received by the processor 12. In one embodiment, after appropriate funding of the gaming machine 10, the input device 30 is a game-activation device, such as a play button 32 or a pull arm (not shown) which is used by the player to start any primary or base game or sequence of events in the gaming machine 10. The play button 32 can be any suitable play activator such as a bet-one button, a max-bet button, or a repeat-the-bet button. In an embodiment, upon appropriate funding, the gaming machine 10 may begin game play automatically. In another embodiment, upon the player engaging one of the play buttons 32, the gaming machine 10 automatically activates game play.

In an embodiment, one input device may be a bet one button. The player may place a bet by pushing the bet-one button 32. The player can increase the bet by one credit each time the player pushes the bet-one button 32. When the player pushes the bet-one button 32, the number of credits shown in the credit display 20 preferably decreases by one, and the number of credits shown in the bet display preferably increases by one. In another embodiment, one input device 30 is a bet-max button (not shown) which enables the player to bet the maximum wager permitted for a game of the gaming machine 10.

In one embodiment, one input device is a cash out button 34. The player may push the cash out button 34 and cash out to receive a cash payment or other suitable form of payment corresponding to the number of remaining credits. In one embodiment, when the player cashes out, a payment device, such as a ticket, payment, or note generator 36 prints or otherwise generates a ticket or credit slip to provide to the player. The player receives the ticket or credit slip and may redeem the value associated with the ticket or credit slip via a cashier (or other suitable redemption system).

In another embodiment, when the player cashes out, the player receives the coins or tokens in a coin payout tray. In one embodiment, the gaming machine 10 includes at least one card reader 38 in communication with the processor 12. In this embodiment, a player is issued a player identification card which has an encoded player identification number that uniquely identifies the player. When the player inserts their playing tracking card into the card reader 38 to begin a gaming session, the card reader 38 reads the player identification number off the player tracking card to identify the player. Any suitable payout mechanism, such as funding to the player's electronically recordable identification card or smart card, may be implemented in accordance with the gaming machine 10.

In one embodiment, as mentioned above and as seen in FIG. 2A, one input device may be a touch-screen 42 coupled with a touch-screen controller 44 or some other touch-sensitive display overlay to allow for player interaction with the images on the touch screen 42. The touch-screen 42 and the touch-screen controller 44 may be connected to a video controller 46. A player can make decisions and input signals into the gaming machine 10 or the electronic system 11 by touching the touch-screen 42 at the appropriate locations. One such input device is a conventional touch-screen button panel.

The electronic system 11 may further include a plurality of communication ports for enabling communication of the processor with external peripherals, such as external video sources, expansion buses, game or other displays, a SCSI port, or a keypad.

In an embodiment, as seen in FIG. 2A, the electronic system 11 may include a sound generating device controlled by one or more sounds cards 48 which function in conjunction with the processor 12. In one embodiment, the sound-generating device includes at least one and preferably a plurality of speakers 50 or other sound-generating hardware and/or software for generating sounds. The sound-generating device may, for example, play music for the primary and/or secondary game or play music for other modes of the gaming machine 10, such as an attract mode.

In one embodiment, the gaming machine 10 may provide dynamic sounds coupled with attractive multimedia images displayed on one or more of the display devices 16, 18, 40 to provide an audio-visual representation or to otherwise display full-motion video with sound to attract players to the gaming machine 10. During idle periods, the gaming machine 10 may display a sequence of audio and/or visual attraction messages to attract potential players to the gaming machine 10. The videos may also be customized to provide any appropriate information.

In one embodiment, the gaming machine 10 may include a sensor, such as a camera, in communication with the processor 12 (and possibly controlled by the processor 12), that is selectively positioned to acquire an image of a player actively using the gaming machine 10 and/or the surrounding area of the gaming machine 10. In one embodiment, the camera may be configured to selectively acquire still or moving (e.g., video) images and may be configured to acquire the images in an analog, digital, or other suitable format. The display devices 16, 18, 40 may be configured to display the image acquired by the camera as well as to display the visual features of the game in split screen or picture-in-picture fashion. For example, the camera may acquire an image of the player and the processor may incorporate that image into the primary and/or secondary game as a game image, symbol or indicia.

The gaming machine 10 may incorporate a bingo based wagering game as the primary or base game and may incorporate a table game as the secondary game or as the entertaining display game. The gaming machine 10 may include some or all of the features of conventional gaming machines or devices.

In one embodiment, as illustrated in FIG. 1, an entertaining display may be provided on the gaming machine corresponding to a secondary game 52. In various embodiments, the gaming machine 10 may include one or more secondary game elements 54, such as a roulette table, a craps table, a roulette wheel, cards, dice, or the like, in either electromechanical form with mechanical elements or video form with simulated elements and movement thereof. The secondary game elements 54 preferably correspond to a theme associated with one or more secondary game 52 of the gaming machine 10. The gaming machine 10 may control the secondary game elements 54 of the entertaining display to be displayed in an arrangement corresponding to a result of the player's wager.

In one embodiment, as illustrated in FIG. 2B, a gaming system according to the present disclosure is generally shown at 56. The gaming system 56 may include at least one central controller 58 and one or more gaming controllers or devices 60 in communication with each other and/or the at least one central controller 58 through a data network or remote communication link 62. In this embodiment, the central server, central controller, central computer, or remote host is any suitable server or computing device which includes at least one processor and at least one memory or storage device. In different such embodiments, the central server is a progressive controller or a processor of one of the gaming machines in the gaming system.

In these embodiments, the processor of each gaming machine is designed to transmit and receive events, messages, commands, or any other suitable data or signal between the individual gaming machine and the central server. The gaming machine processor is operable to execute such communicated events, messages, or commands in conjunction with the operation of the gaming machine. Moreover, the processor of the central server is designed to transmit and receive events, messages, commands, or any other suitable data or signal between the central server and each of the individual gaming machines. The central server processor is operable to execute such communicated events, messages, or commands in conjunction with the operation of the central server. One, more or each of the functions of the central controller, central server or remote host as disclosed herein may be performed by one or more gaming machine processors. One, more or each of the functions of one or more gaming machine processors as disclosed herein may be performed by the central controller, central server or remote host.

In one embodiment, a plurality of the gaming machines 60 are capable of being connected together through a data network. In one embodiment, the data network is a local area network (LAN), in which one or more of the gaming machines 60 are substantially proximate to each other and an on-site central server or controller as in, for example, a gaming establishment or a portion of a gaming establishment. In another embodiment, the data network is a wide area network (WAN) in which one or more of the gaming machines are in communication with at least one off-site central server or controller. In this embodiment, the plurality of gaming machines 60 may be located in a different part of the gaming establishment or within a different gaming establishment than the off-site central server or controller. Thus, the WAN may include an off-site central server or controller and an off-site gaming machine located within gaming establishments in the same geographic area, such as a city or state. The WAN gaming system may be substantially identical to the LAN gaming system described above, although the number of gaming machines in each system may vary relative to one another.

In another embodiment, the data network 62 may be include the internet or an intranet. In this embodiment, the operation of the gaming machine 60 may be viewed at the gaming machine 60 using at least one internet browser implemented thereon. In this embodiment, operation of the gaming machine 60 and accumulation of credits may be accomplished with only a connection to the central server or controller 58 (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer or other internet facilitator is available. The expansion in the number of computers and number and speed of internet connections in recent years increases opportunities for players to play from an ever-increasing number of remote sites. The enhanced bandwidth of digital wireless communications may render such technology suitable for some or all communications, particularly if such communications are encrypted. Higher data transmission speeds may be useful for enhancing the sophistication and response of the display and interaction with the player.

As mentioned above, embodiments may be employed in a server-based gaming system. In one such embodiment, as described above, one or more gaming machines 60 may be in communication with a central server or controller 58. The central server or controller 58 may be any suitable server or computing device which includes at least one processor and a memory or storage device. In alternative embodiments, the central server is a progressive controller or another gaming machine in the gaming system. In one embodiment, the memory device of the central server stores different game programs and instructions, executable by a gaming machine processor, to control the gaming machine. Each executable game program may represent a different game or type of game which may be played on one or more of the gaming machines in the gaming system. Such different games may include the same or substantially the same game play with different pay tables. In different embodiments, the executable game program is for a primary game, a secondary game or both. In another embodiment, the game program may be executable as a secondary game to be played simultaneous with the play of a primary game (which may be downloaded to or fixed on the gaming machine) or vice versa.

In this embodiment, each gaming machine 60 at least includes one or more display devices and/or one or more input devices for interaction with a player. A local processor, such as the above-described gaming machine processor or a processor of a local server, is operable with the display device(s) and/or the input device(s) of one or more of the gaming machines.

In operation, the central controller 58 may be operable to communicate one or more of the stored game programs to at least one local processor. In different embodiments, the stored game programs may be communicated or delivered by embedding the communicated game program in a device or a component (e.g., a microchip to be inserted in a gaming machine), writing the game program on a disc or other media, or downloading or streaming the game program over a dedicated data network, internet, or a telephone line. After the stored game programs are communicated from the central server, the local processor may execute the communicated program to facilitate play of the communicated program by a player through the display device(s) and/or input device(s) of the gaming machine. That is, when a game program is communicated to a local processor, the local processor changes the game or type of game played at the gaming machine.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

The methodologies described herein may be implemented by various means depending upon applications according to particular examples. For example, such methodologies may be implemented in hardware, firmware, software, or combinations thereof. In a hardware implementation, for example, the controller or processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the description included herein are presented in terms of algorithms or symbolic representations of operations on binary digital signals stored within a memory of a specific apparatus or special purpose computing device or platform. In the context of this particular specification, a specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be appreciated, however, that all of these or similar terms are to be associated with appropriate physical quantities and are merely convenient labels. Unless specifically stated otherwise, as apparent from the discussion herein, throughout this specification discussions utilizing terms such as “processing,” “computing,” “calculating,” “determining” or the like refer to actions or processes of a specific apparatus, such as a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

For clarity in discussing the various functions of the system, multiple computers and/or servers are discussed as performing different functions. These different computers (or servers) may, however, be implemented in multiple different ways such as modules within a single computer, as nodes of a computer system, etc. The functions performed by the system (or nodes or modules) may be centralized or distributed in any suitable manner across the system and its components, regardless of the location of specific hardware. Furthermore, specific components of the system may be referenced using functional terminology in their names. The function terminology is used solely for purposes of naming convention and to distinguish one element from another in the following discussion. Unless otherwise specified, the name of an element conveys no specific functionality to the element or component. In selected embodiments, the software, hardware, and associated components of the system may be programmed and configured to implement one or more embodiments described herein. The various aspects of the system may be exemplified as software, modules, nodes, etc. of a computer or server device.

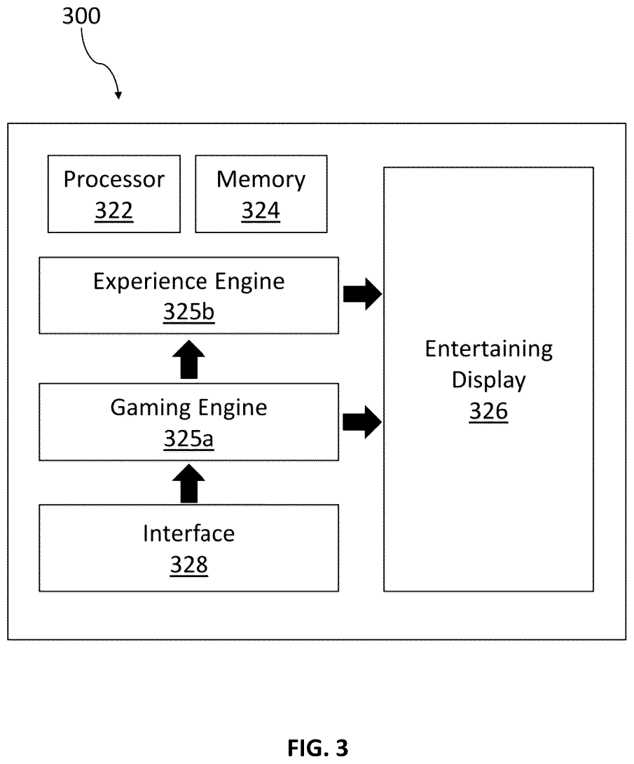

FIG. 3 illustrates an embodiment of a gaming system 300 comprising a processor 322 and a memory 324 for operating a corresponding entertaining display 326 and a corresponding user interface 328. In operation, the gaming system 300 is arranged to facilitate an input by a player, such that a corresponding gameplay request is sent to a gaming engine 325a and subsequently to an experience engine 325b.

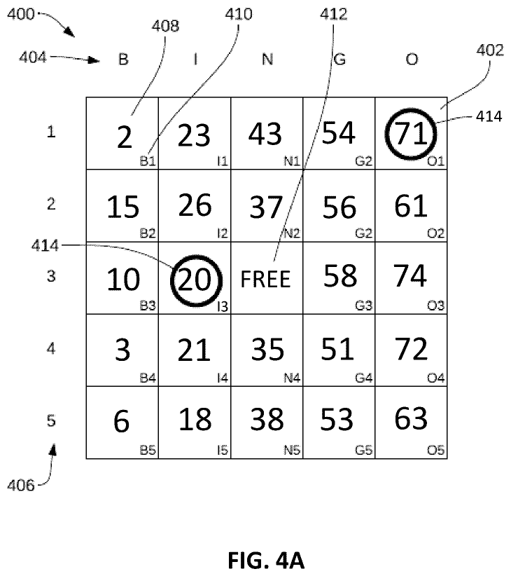

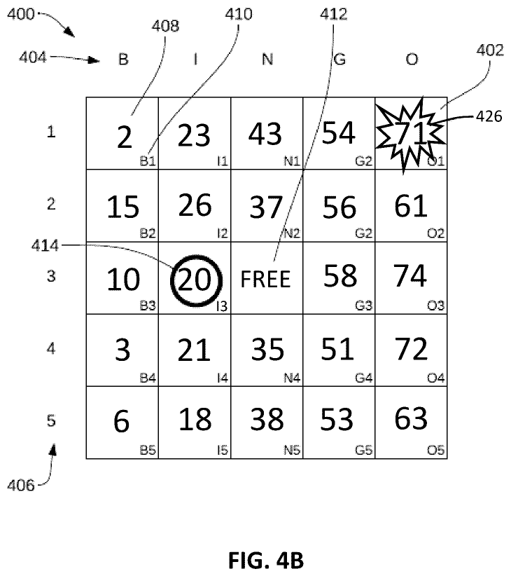

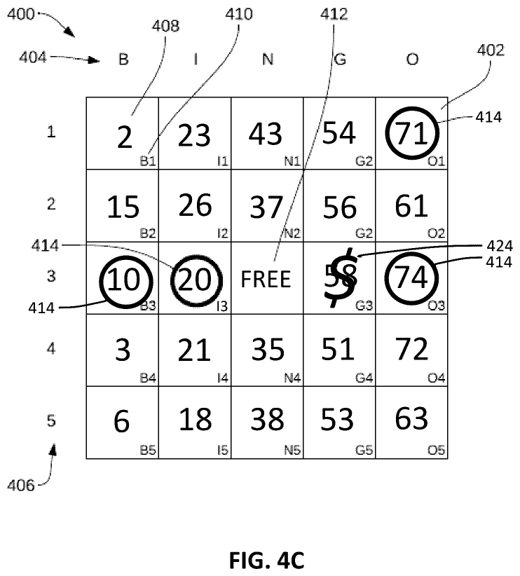

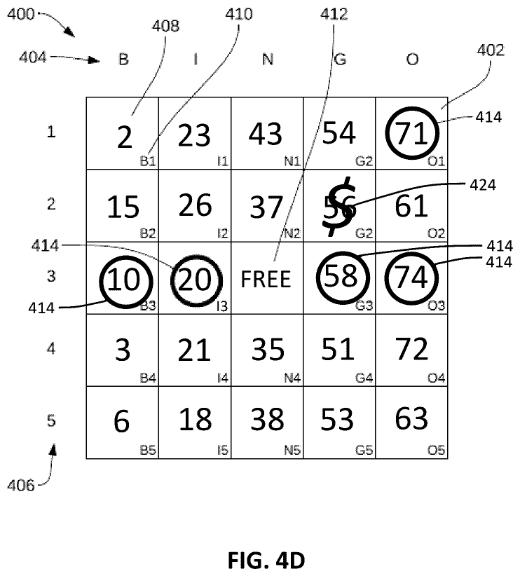

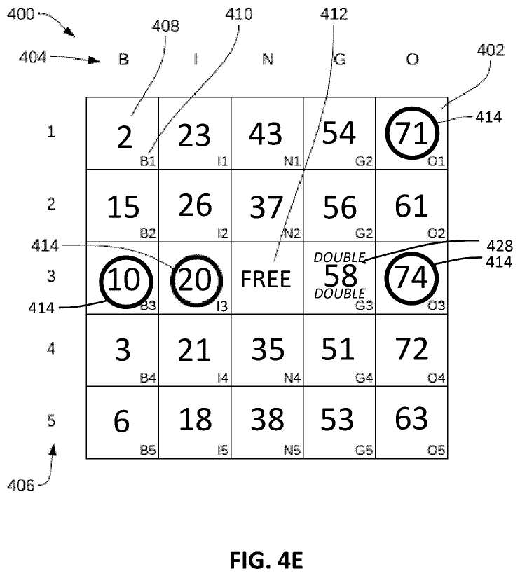

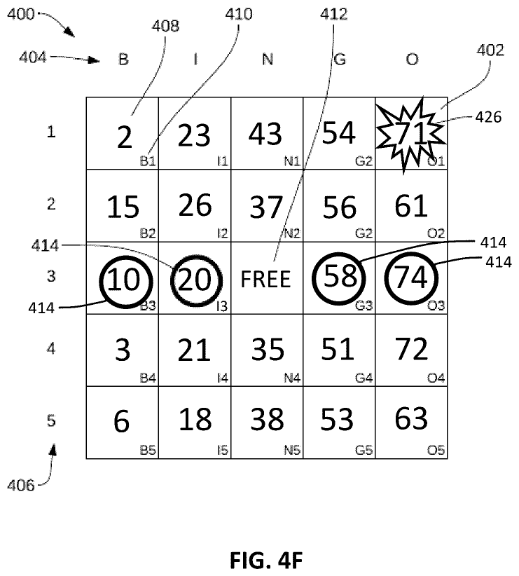

FIG. 4A is an illustration of a related Bingo game 400. Elements of the Bingo game 400 include a Bingo card 402 having in this example a traditional 5×5 layout consisting of columns 404 labeled with the letters “B” “I” “N” “G” and “O,” and rows 406 labeled with numbers 1-5. Although the rows are numbered 1-5 in this example for ease in describing the concepts herein, generally in a Bingo game, as displayed to a user or player, the rows would not be shown as numbered. There typically is a “FREE” space 412 that is conventionally located in the center of the card 102 (at column N and row 3). Each space has an identifier 408 that can be a number, a letter, a symbol, or other indicia, and for ease of description, coordinates 410 including such as B1, are shown herein, although as noted, these would typically not be shown to the player. As used herein, the coordinates 110 for the rows ascend from 1-5 and the columns ascend from B to I to N to G to O. Traditionally, the game of Bingo is played by distributing one or more cards 102 to the players, each card having a different arrangement of identifiers 408 on each space. Numbers indicative of the space identifiers are selected randomly and “called” as a “ball call”. It is noted that ball calls can be random, or produced by a random number generator, or pulled from numbered balls in a basket, or can be based on a very long pattern that would be unrecognizable to the players. Players having a space identifier corresponding to the announced identifier (“ball call”) will place themselves (when playing the game in a physical form) or when playing in an electronic form, will have a daub 414 placed on the identifier. So using the example in FIG. 4A, when the number “20” or “I-20” is called as a ball call, the player will place a “daub” over the space of I-3 which has the identifier 408 of “20”. When played in an electronic form, the gaming system shows on the display that shows the player's bingo card 402 the space I-3 having the identifier of “20” called as a ball call by generating and showing a daub 414, which is placed on the called identifier of “20” at space I-3. Similarly, the gaming system shows on the display that shows the player's bingo card 402 the space O-1 having the identifier of “71” called as a ball call by generating and showing an identical daub 414, which is placed on the called identifier of “71” at space O-1. The ball calls may be made sequentially over a period of time, or in an electronic form, the ball calls may be called, generated, or provided as a set in a listed sequence. A win is determined when a player meets prescribed criteria, such as a complete row, column, a diagonal, predetermined patterns, such (but not limited to) as an arrow, flame, numbers, checkerboard, chevron, “X”, pyramid, inverted pyramid, or a blackout (all spaces being “daubed”). In this related example, the daubs 414 placed over identifier “20” at space I-3 and identifier “71” at space O-1 are identical, that is they are shown with the same icon, which is typical in electronic Bingo games. In the example of FIG. 4A, the daubs are both shown with a simple bold line circle.

In some embodiments, an award or payout associated with a winning pattern of a final result index may be based on additional factors outside of the pattern itself. In some cases a certain characteristic of the daubed spaces forming the pattern may influence the award or payout, for example where a pattern is formed by all even numbered spaces or all odd numbered spaces or alternating even/odd numbered spaces or another attribute or characteristic is present, a bonus or multiplier effect or some other benefit to the player may be provided. In another aspect, where the daubs on the bingo card only form the winning pattern with no other spaces being daubed a bonus or multiplier effect or some other benefit to the player may be provided. In another aspect, where the daubs on the bingo card daub all of the spaces except for the winning pattern a bonus or multiplier effect or some other benefit to the player may be provided. Alternatively, or in addition to such positive effects, certain characteristics of the pattern may be configured to have a negative effect.

It is noted that in an electronic Bingo game, as shown, for example, in FIG. 4A which may be displayed on a display of a terminal of an electronic Bingo wagering system, the sequence of ball calls may be predetermined and repeated in a small pattern of ball calls sequences or the same ball call may be repeatedly used. This allowed for rapid play of the electronic Bingo game, as the player does not wait for the ball calls to be successively made, but rather upon initiating the game play, the player is provide a Bingo card, wherein the space identifiers of the Bingo card are randomly filled. Then, once the card is provided to the player, the Bingo card space identifiers are compared to the ball calls that have already been called or determined. So the Bingo game can be nearly instantaneous with the generation and providing of the Bingo card to the player, when the Bingo game is played electronically. It is further noted that in the embodiments described herein, the Bingo cards are shown or described as 5×5 Bingo cards, having five columns and five rows or spaces with corresponding space identifiers. However, the concepts of this disclosure should not be construed or limited to such an arrangement. Indeed, the concepts of this disclosure could be implemented with varying or different arrays of spaces, including in different numbers of columns and rows (for example, but not limited to arrays of spaces such as 3×11, 3×15, 7×7, 3×3, 3×4, 3×5, 4×4, 6×6 7×7, 10×10, etc.). Further the Bingo cards are not to be limited to symmetric shapes and arrays, but may be of different shapes or asymmetric. And the grid of the spaces need not be in a perpendicular grid but may be of any shape, size, geometry or orientation.

In a preferred embodiment, as shown FIG. 4B, similar features are identified with the same reference characters. In the example of FIG. 4B, rather than having the daubs represented with the same icon or character (such as the bold lined circle of daubs 414 of FIG. 4A), in the example of FIG. 4B, the daubing icons include two or more different daubs. For example, when the ball call of “20” is made, daub 414 is generated and shown over space 13 as a bold lined circle. However, when the ball call of “71” is made, a daub 426 including an exploding icon is shown over the number 71 in space O-1.

In a further embodiment, as shown in FIG. 4C, the line or row 3 may be daubed with daubs 414 as the ball calls are made for the identifiers “10” “20” and “74” (and the free space). But upon a ball call for the identifier “58” of space G-3, the electronic system may randomly generate and show a different type of icon, in this example, a dollar sign “$” icon which is shown to overlay the identifier “58” in the space G-3. Accordingly, this sequence of ball calls may result in a win of a prize due to the line of row 3 having been daubed, therefore satisfying a predetermined pattern. But in the example of due to the generating and showing of a dollar sign “$” icon as a daub, an some benefit may be given to the player, such as an increased prize, an additional prize, or a type of bonus, such as granting a free bingo card for additional play may be given to the player due to the generated daub icon. With the introduction of a plurality of types of daubs, player interest in the game is heightened, as different daubs can have different consequences of the outcome of the game.

In the example of FIG. 4D, the line or row 3 may be fully daubed with daubs 414 as the ball calls are made for the identifiers “10” “20” “58” and “74” are called (and the free space). But upon a ball call for the identifier “56” of space G-2, which is not in row 3 nor related to row 3, the electronic system may randomly generate and show the dollar sign icon “$”, which may result in the player being given an additional prize or benefit, in addition to the prize based on the line of row 3 having been daubed, therefore satisfying a predetermined pattern. That is, the player having the card 402 in FIG. 4D may be allotted a prize for achieve the line of row 3 daubed, and then may be given an additional prize, benefit, or bonus due to having received an (unrelated) daubing with daub 424 that is randomly generated in for the space of G2 that is daubed over the identifier of 56.

In a further embodiment, as shown in FIG. 4E, the line or row 3 may be daubed with daubs 414 as the ball calls are made for the identifiers “10” “20” and “74” (and the free space). But upon a ball call for the identifier “58” of space G-3, the electronic system may randomly generate and show a different type of icon, in this example, “DOUBLE DOUBLE” icon which is shown to overlay the identifier “58” in the space G-3. In this instance, due to the “DOUBLE DOUBLE” icon being generated as the daub for one of the spaces that satisfies or achieves the predetermined pattern (in this case a line), the player can be awarded double the usually prize that would be awarded to the player had the predetermined pattern been satisfied and only the bold lined circled daubs 414 been generated to show the ball calls for the entire row or line. With the introduction of a plurality of types of daubs, player interest in the game is heightened, as different daubs can have different consequences of the outcome of the game.

Further, it may be the case that the daub that is generated by the electronic Bingo system has a negative effect on the player. For example, in the embodiment of the game shown in FIG. 4F, the line or row 3 may be fully daubed with daubs 414 as the ball calls are made for the identifiers “10” “20” “58” and “74” are called (and the free space). But upon a ball call for the identifier “71” of space O-1, which is not in row 3 nor related to row 3, the electronic system may randomly generate and show the explosion icon 426, which may result in the player having the prize that would be awarded due to achieving the line of row 3 as a predetermined pattern lessened due to the generation of the explosion icon 426. That is, the player having the card 402 in FIG. 4F may be allotted a reduced prize for achieving the line of row 3 daubed due to the explosion icon 426 having been randomly generated in a ball call of the identifier “71”.

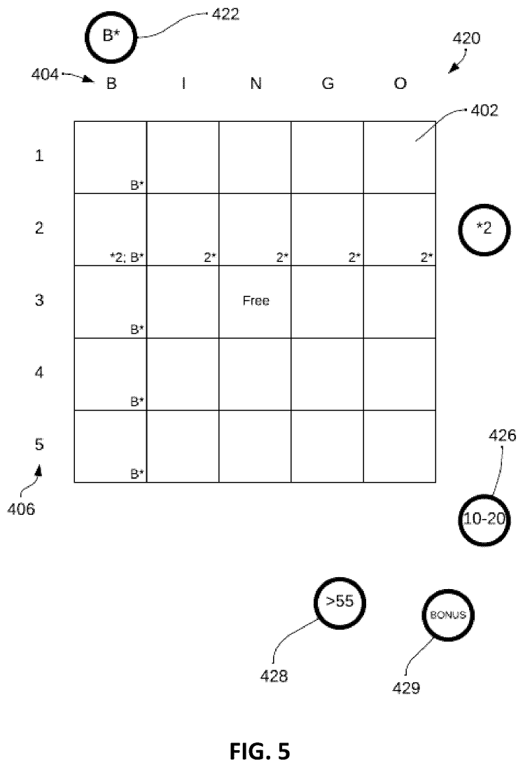

In another embodiment, FIG. 5 is an illustration of a variation of a Bingo game 420 including what may be termed “wildcard” daubs according to embodiments of the present disclosure. The Bingo game 420 may have rules similar to traditional Bingo games, including the card 402, the columns 404, and the rows 406 and the general order of play and winning conditions. The Bingo game 420 also includes daubs that may be applied to more than one space. These daubs can be generated at random to increase the chance for a win and the excitement level of the Bingo game 420. One such daub is a wildcard daub 422 that includes an indication that the daub 422 may be placed on any space in the “B” column. One such indication can be an asterisk (*). If the card has an identifier corresponding to a space on the card 102, and the daub that is chosen is a wildcard daub 422, the player may place the wildcard daub 422 on any space in the column. Or in the case of an electronic Bingo system, the electronic gaming system may determine and place the wildcard daub 422 in the space that would be most advantageous to the player to achieve the greatest award or prize or bonus. A similar wildcard daub 424 can be for rows in the Bingo card. In the shown embodiment the wildcard daub 424 is valid on any space in the row “2.” Other variations of wildcard daubs 426 include a range of indicators upon which the wildcard daub 426 may be placed. One such range can be any indicator between 10-20. Another such wildcard daub 428 can be any indicator greater than 55. Other numbers and ranges can be used. These wildcard daubs are more valuable because of their flexibility and ability to cover more than one space if the indicator is chosen. Accordingly, these wildcard daubs can be relatively rare.

In other embodiments a bonus daub 429 can be part of the Bingo game 420. In some Bingo games, there are a set number of calls that will be made, after which the game ends. For discussion, in a certain Bingo game there are 40 ball calls. The player must achieve a win before the 40 ball calls are given. The bonus daub 429 may be generated due to a ball call but does not count toward the 40-call total, giving the player(s) a greater chance to win the Bingo game 420. These calls are therefore “free” in terms of not counting toward the total count that ends the Bingo game 420.

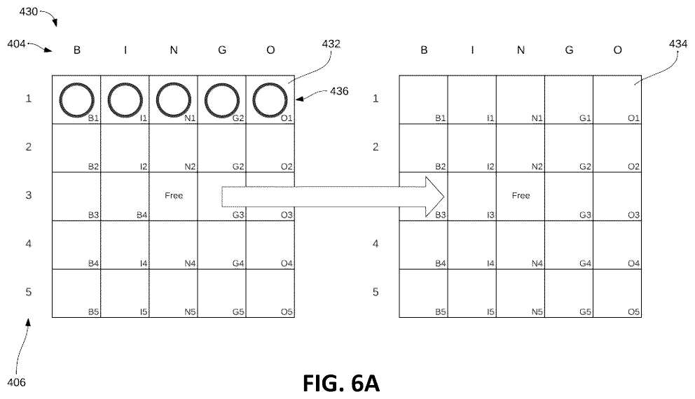

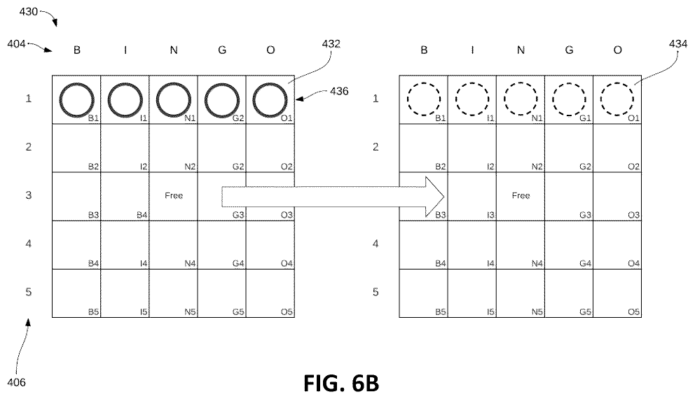

FIG. 6A illustrates another Bingo game 430 with an additional card according to embodiments of the present disclosure. The Bingo game 430 can include familiar elements such as a card 432 having columns 404 and rows 406, each having an indicator (not shown) that, when called, allows the player to “daub” that space. A win condition can be any predetermined pattern, such as a complete row, column, diagonal, or blackout. In the shown embodiment the card 402 has reached a prize-winning condition of having five aligned daubs along the row “1.” In response to the win, a second card 434 is generated and presented to the player as a bonus, which may itself be compared to the ball call sequence that was applied to the first card 432. The second card 434 can be a new card having all new space identifiers, or may have some similarities in space identifiers. The Bingo game 430 may continue, with other players (if any) continuing their run, and the winning player alone has the second card 434.

In some embodiments, as shown in FIG. 6B the second card 434 can include carryover daubs 438 that were placed on the first card 432. In some embodiments the carryover daubs 438 are worth less than daubs placed directly onto the second card 434. The carryover daubs 438 can be presented in phantom lines or with other indications that the carryover daubs 438 are not the same as standard daubs 436 on the first card 432 or the second card 434. The player may be presented with a choice while the second card 434 is active to activate one or more of the carryover daubs 438. Suppose, for example, the player has placed one or more daubs onto the second card 434, but has not yet or will not achieve a win using purely daubs placed onto the second card 434. If one or more of the carryover daubs 438, if they became active on the second cards 434, would achieve a win, the player can choose to activate the carryover daubs 438 and achieve the win on the second card 434. One or more of the carryover daubs 438 can be selected. In some embodiments the carryover daubs 438 can be selected directly and individually by the player. In other embodiments the player may make choice to activate one or more of the carryover daubs 438 without being able to choose which carryover daub 438 will be activated. The player may be able to spend resources (money, or another in-game resource) to activate one or more carryover daubs 438. There may be an inverse relationship between the resources spend activating carryover daubs 438 and the payout associated with a win that includes carryover daubs 438. Also, the more carryover daubs 438 used to achieve the win, the less the associated payout will be.

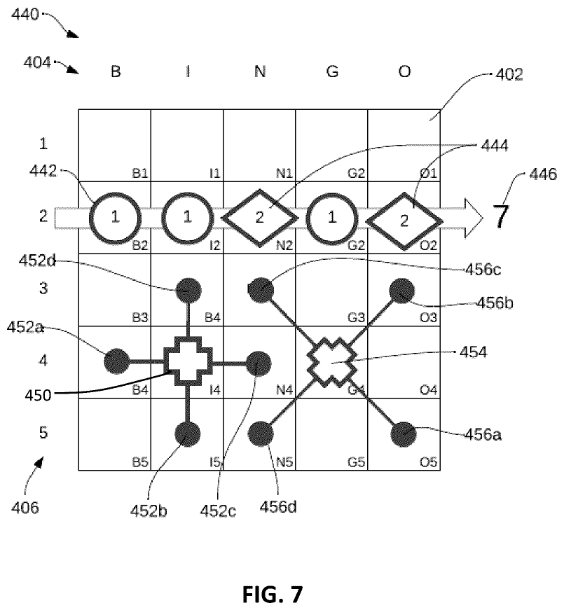

FIG. 7 is an illustration of a Bingo game 440 and variations including daubs of differing values according to embodiments of the present disclosure. The Bingo game 440 can include familiar elements including a card 402, columns 404, rows 406, and space identifiers (not shown). The order of play may also be familiar with calls being made at random, resulting in a daub placed in a space on the card 402. There may be first daubs 442 having a first value, and second daubs 444 having a second value. The respective values may be any arbitrary or predetermined number, and there may be third daubs and fourth daubs, etc. For purposes of discussion, in this example, the first daubs 442 are worth 1, and the second daubs 444 are worth 2. In the illustrated embodiment the player has achieved a complete row with first daubs 442 being placed in the B, I, and G spaces, and with second daubs 444 being placed in the N and O spaces. The row is a win, and the total value of the win is equal to the sum of the daub values, which in this case is 7, shown at 446. The Bingo game 440 can display a graphical depiction of the win including the value of the payout expressed in terms of the sum of the daubs' value. In other embodiments the daubs' value is a multiplier of the values of the daubs. In yet other embodiments there may be different mathematical values associated with the different daubs. The values of the daubs can be announced before the identifier for the daub, to increase the anticipation and excitement of the Bingo game 440. Or in the case of a nearly-instantaneous electronic Bingo game, the value of the daubs can be shown to on the display to increase anticipation and excitement. There may be an inverse relationship between the value of the daubs and the frequency of occurrence of the daubs. The first daubs 442 and second daubs 444 are represented with different symbols, such as the circles for the first daubs 442 and the diamonds for the second daubs 444. There may be additional indicia to show the value of the daubs that generally corresponds with the value of the daubs. Ordinary daubs having a low value can have a mundane presentation in terms of color, movement, and shape, while higher value daubs can have escalating appearance corresponding to their value. Different colors, sparkles, movements, and shapes can be presented to increase the interest in the Bingo game 440 and to represent the value for the daubs.

The Bingo game 440 can also include multispace daubs according to embodiments of the present disclosure. Multispace daubs may be randomly occurring, relatively rare events in the Bingo game 440. An orthogonal multispace daub 450 can include a main body in the form of a cross that is placed upon a corresponding space if a call is announced, and the card has a corresponding space according to the indicator on the card 402. The orthogonal multispace daub 450 can also have extensions 452a, 452b, 452c, and 452d, that extend outwardly from the main body and cover spaces around the main body. These extensions can count as daubs on those spaces, resulting in a much higher chance for a win than ordinary single-space daubs. If one or more of the extensions overlap with a previously placed daub, the space remains covered. Another variation of multispace daub is the diagonal multispace daub 454 which includes a main body and extensions 456a, 456b, 456c, and 456d. Other shapes of multispace daubs are also envisioned, including multispace daubs having a different number of extensions, and multispace daubs having different distances between the extension and the main body.

In another embodiment, the daubs can be randomly selected as chess pieces: pawns, castles, bishops, knights, rooks, queens, and kings. The Bingo card can be presented as a chess board, and each daub can make one move when called, and the path of the move covers the spaces in the path. For example, a knight daub can cover two spaces in a first direction, and a third space in a second direction. The player may choose the direction of the “move” or the electronic Bingo game may automatically move the daub in the direction that would be most favorable to the player.

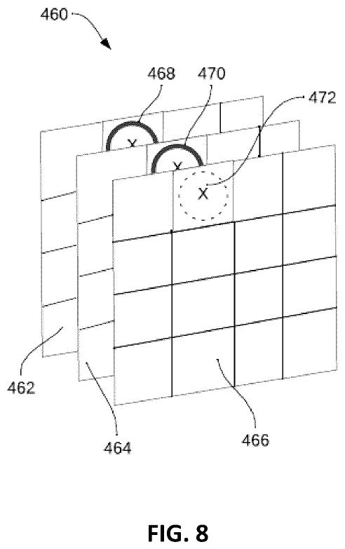

FIG. 8 illustrates a Bingo game 460 and variations having layered Bingo cards according to embodiments of the present disclosure. The Bingo game 460 can include two or more cards arranged in an overlapping, layered pattern. A first card 462, a second card 464, and a third card 466 are shown. There may be any desired number of cards according to this embodiment. The cards can be played consecutively, or simultaneously. Daubs from one of the cards can apply in one or more of the other cards. For example, a daub 468 can be placed on the first card 462 and can apply to the second card 464. In the second card 464 the daub may be a carryover daub 470. In the third card 466 the daub can be displayed as a projected daub 472 that can be portrayed to the player as an option that the player can exercise to render the projected daub 472 valuable in the third card 466. The display of the cards can be in three dimensions similar to FIG. 8. In some embodiments the cards can be rotated and translated around the display using an input device such as a mouse or a touch-sensitive input to allow the player to see the different cards and the status of each. The cards can be moved closer to one another or farther apart to allow greater visibility of the cards. The player may select a card to highlight the card, which may change the display of the other cards to a transparent or phantom status so as to not obscure the highlighted card or cards.

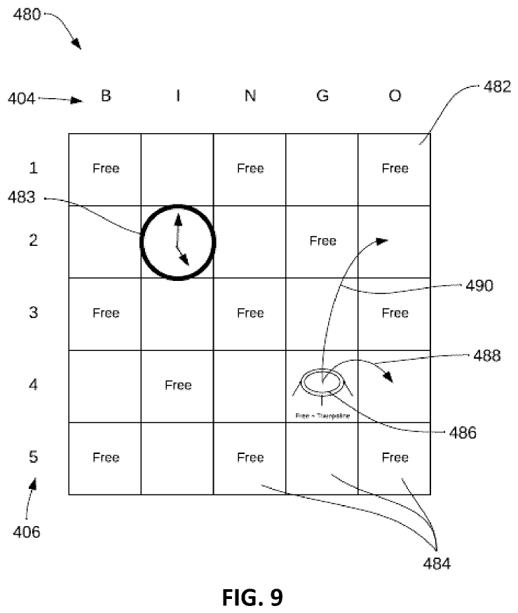

FIG. 9 is an illustration of a Bingo game 480 and variations having alternate free space patterns according to embodiments of the present disclosure. The Bingo game 480 can include familiar elements including the card 482, columns 404, rows 406, and spaces. The card 482 can include a pattern of free spaces such as the checkered layout shown here, or another suitable free space pattern. The free spaces can be achieved during play as random rewards for the player. The card 482 may initially have one or zero free spaces, and as random rewards that may be related to calls, or at least given to the player in combination with the calls, additional free spaces or patterns of free spaces can be given. In some embodiments one or more of these free spaces can be temporary free spaces 483. Some of the free spaces could be temporary in that they will last for the next few calls, and if there is no win during the next few calls, the temporary free spaces will expire.

An additional variation can be in the form of a space identifier 486 that, in addition to counting as a free space, the trampoline identifier 486 can “bounce” a daub from that space to another, randomly selected space on the card 482. The trampoline identifier 486 can be depicted as a trampoline or another attractive, humorous symbol that, in an entertaining way, distributes that daub elsewhere. A visual animation of the transfer can be made on the display in the case of an electronic Bingo game 480, such as 488 and 490 showing an arcing trajectory for the transferred daub.

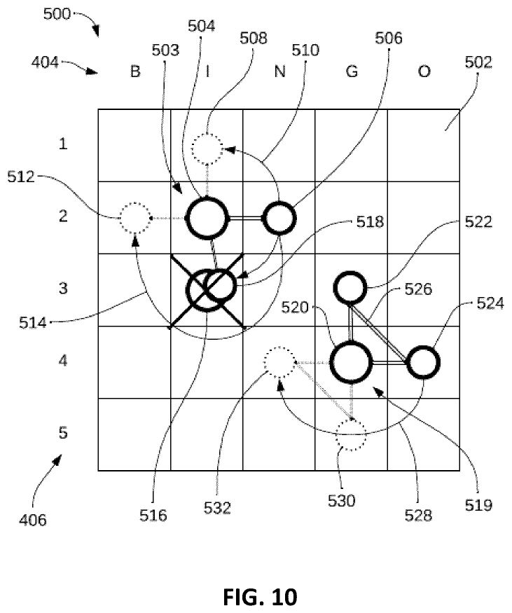

FIG. 10 is another illustration of a Bingo game 500 including movable daubs are applied according to embodiments of the present disclosure. The Bingo game 500 can include familiar elements such as a card 402, columns 404, and rows 406. The Bingo game 500 can include standard daubs covering single spaces, and intermittent, randomly assigned movable daubs. One example is a movable daub 503 that includes a root daub 504 that is placed at the space corresponding to the indicator for that space when that indicator is called. The movable daub 503 also has a companion daub 506 that is attached to the root daub 504, similar to the extensions shown and described herein elsewhere. The daub can be rotated around to move the companion daub 506 to a different space on the card 402. For example, the companion daub 506 can initially be shown to the right of the root daub 504, and the player can, through an input interface such as a mouse, keyboard, or touch interface, can rotate the companion daub 506 to another position relative to the root daub 504. Or, alternatively, in an electronic Bingo context, the electronic Bingo machine can automatically rotate or move the companion daub 506 to another position relative to the root daub 504 in a way that would provide the player the maximum possible benefit or prize. For example, rotating the companion daub 506 to the space above the root daub 504 moves the companion daub 506 along a path 510 to the space “I1” at 508. Alternatively, the companion daub 506 can be rotated in the other direction along a path 514 to the “B2” space 512 to the left of the root daub 504.

In the case of overlap between a companion daub 506 and another existing daub 516 can have a variety of consequences. In some embodiments the overlap can cause both daubs to be removed from the board. In other embodiments the overlap can cause the daubs to combine to increase their value, and the value can be calculated in the event of a win including that combined daub.

Another feature of the Bingo game 500 that involves movable daubs is a multicompanion daub 519 that includes a root daub 520, a first companion daub 522 and a second companion daub 524 that are connected with an arm 524. The root daub 520 can be placed and remains stationary and the companion daubs 522 and 524 can be rotated together or independently. For example, the companion daubs can be moved along a path 528 from the spaces above and to the right of the root daub 520, to the spaces to the left of and below the root daub 520, shown in phantom at 530 and 532. The companion daubs may be movable in rotation or in translation. In some embodiments the companion daubs are movable for a short time, requiring the player to respond quickly to place the daubs in an advantageous position. This adds an element of excitement, especially when considering the possibility of an overlap having negative consequences such as knocking out an existing daub, or in the case of a positive consequence such as a multiplication or addition with an overlapping daub, there is little time to capture this value.

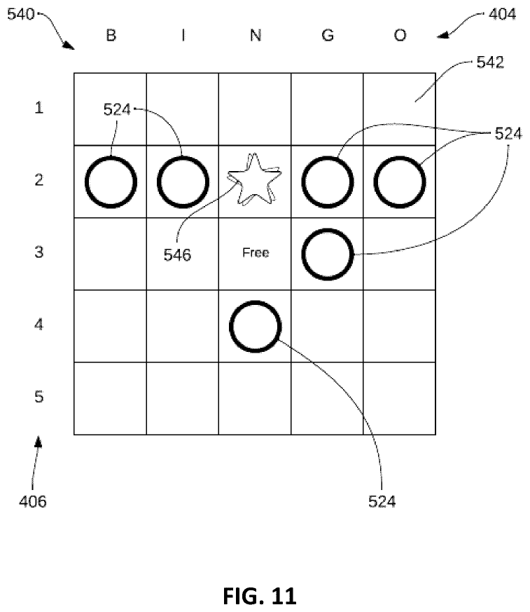

FIG. 11 is another illustration of a Bingo game 540 including anticipatory markers according to embodiments of the present disclosure. The Bingo game 540 includes familiar elements such as a card 542, columns 404, rows 406, etc. In the depicted embodiment there are daubs 524 on the “2” row that nearly complete a win. If a daub is placed on the N2 space the card is a winner and a prize is awarded. To emphasize this and to increase excitement and anticipation, a marker 546 can illuminate in anticipation of a possible call that would result in a win. The marker 546 can be a star, or another exciting symbol that can include flashy animations, a pulsation, a color, or another highlight of the N2 space. In the case of a win, the marker 546 can increase in intensity and combine with an exciting display to emphasize the win. In the case of a near win, such as a call resulting in a daub near a winning space, such as in this example in the N1 space, an indication of disappointment such as an audible groan from a crowd, or a tantalizing display can be shown.

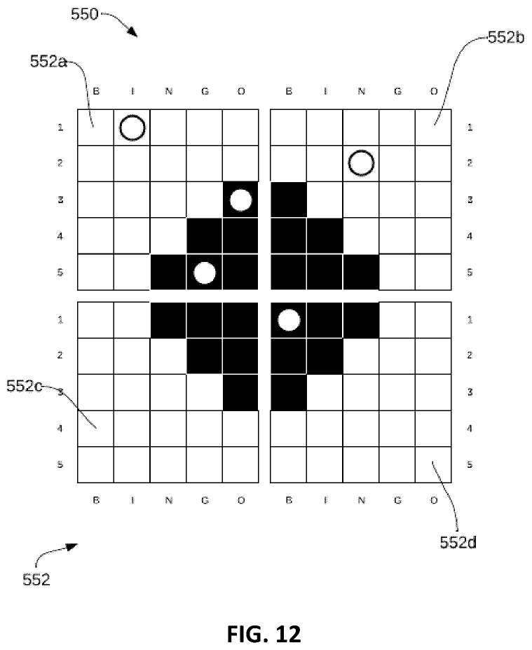

FIG. 12 is another illustration of a Bingo game 550 including variations with multiple cards 552 that, when combined together, form an image to complete a win according to embodiments of the present disclosure. The Bingo game 550 can include multiple cards arranged side-by-side, cards 552a, 552b, 552c, and 552d (collectively cards 552) are each cards in the Bingo game 550. Each card has certain special spaces 554 that are visually distinct from other spaces. When these cards 552 are arranged in this order, the special spaces 554 form an image of a diamond. Completion of the diamond using the different cards 552 can result in a different win condition for the Bingo game 550.

In some embodiments the multiple cards 522 can be combined in a different orientation relative to one another that can achieve a different win condition. The player may make a decision based on where the cards are relative to one another and factoring in the placement of daubs on the cards 522. For example, the win condition could be to achieve a large number of contiguous daubs, and arranging the cards 522 relative to one another to connect groups of daubs to achieve a higher number of contiguous daubs can result in a win or an increased payout in the event of a win.

Further to or additional to the embodiments described herein, other aspects and concepts of an interactive Bingo game may be used as described in U.S. Non-Provisional patent application Ser. No. 18/735,860, which was filed at the USPTO on 6 Jun. 2024, and which is herein incorporated by reference in its entirely. Moreover, other aspects and concepts of an interactive Bingo game may be used as described in U.S. Provisional Patent Application Ser. No. 63/471,354 filed on 6 Jun. 2023, U.S. Provisional Patent Application Ser. No. 63/520,758 filed on 21 Aug. 2023, U.S. Provisional Patent Application Ser. No. 63/590,972 filed on 17 Oct. 2023, and U.S. Provisional Patent Application Ser. No. 63/602,905 filed on 27 Nov. 2023, which applications are also each expressly incorporated herein by reference in their entirety.

Moreover, other aspects and concepts of an interactive Bingo game may be used as described in U.S. Provisional Patent Application Ser. No. 63/459,932 filed on 17 Apr. 2023, U.S. Provisional Patent Application Ser. No. 63/466,924 filed on 16 May 2023, U.S. Provisional Patent Application Ser. No. 63/520,753 filed on 21 Aug. 2023, U.S. Provisional Patent Application Ser. No. 63/583,453 filed on 18 Sep. 2023, and U.S. Provisional Patent Application Ser. No. 63/632,120 filed on 10 Apr. 2024, which applications are each expressly incorporated herein by reference in their entirety.

While the invention has been illustrated and described in detail in the drawings and foregoing description, the same is to be considered as illustrative and not restrictive in character, it being understood that only the preferred embodiments have been shown and described and that all changes, equivalents, and modifications that come within the spirit of the inventions defined by following claims are desired to be protected.

It is to be understood that not necessarily all objects or advantages may be achieved under any embodiment of the disclosure. Those skilled in the art will recognize that the disclosed gaming system and related methods may be embodied or carried out in a manner that achieves or optimizes one advantage or group of advantages as taught without achieving other objects or advantages as taught or suggested.

The skilled artisan will recognize the interchangeability of various disclosed features. Besides the variations described, other known equivalents for various features can be mixed and matched by one of ordinary skill in this art to make or use a gaming system and related methods under principles of the present disclosure. The features described may be adapted to other types of systems, games and regulatory requirements.

Although this disclosure describes certain exemplary embodiments and examples of a gaming system and related methods, the present disclosure extends beyond the specifically disclosed embodiments to other alternative embodiments and/or uses of the disclosure and obvious modifications and equivalents thereof. It is intended that the present disclosure should not be limited by the particular disclosed embodiments described above.

The disclosure further relates to several embodiments as identified by the below numbered embodiments. The present invention is in no way limited to the embodiments described by way of example and represented in the embodiments, and the embodiments are provided only to demonstrate non-limiting examples of possible embodiments of the disclosure.

In addition to the above, further embodiments and examples are provided below as enumerated embodiments.

1-1. A gaming system, comprising:
a display device configured to display an output pertaining to a Bingo game;
an input device configured to accept a wager on one or more outcomes of the Bingo game, and to accept one or more control inputs pertaining to the Bingo game;
a processor; and
a memory configured to store instructions that, when executed by the processor, cause the gaming system to execute the following steps:
   present a Bingo card having a plurality of spaces in a grid, wherein each space has an associated identifier and a location on the card, wherein the identifiers are assigned at random;
   execute a series of calls, each call including an identifier selected at random and a daub selected at random;
   select a daub for each call wherein the daub is displayed on the display device on the card in a space corresponding to the identifier in the call,
      wherein, for each call, the daub is randomly assigned one or more of:
         a display characteristic;
         a value characteristic; or
         a location characteristic;
   identify a combination of daubs relative to the card that satisfies one or more winning conditions; and
   award a payout according to the one or more winning conditions and the wager.

1-2. The gaming system according to any one or a combination of one or more of 1-1 above to 1-11 below, wherein the display characteristic of the daubs comprises one or more of color, movement, and shape displayed on the display device.

1-3. The gaming system according to any one or a combination of one or more of 1-1 to 1-2 above and 1-4 to 1-11 below, wherein the value characteristic comprises a monetary value, and wherein the payout is correlated to the combined value characteristics of the daubs that together satisfy the winning condition for the Bingo game.

1-4. The gaming system according to any one or a combination of one or more of 1-1 to 1-3 above and 1-5 to 1-11 below, wherein the location characteristic comprises a number of spaces on the Bingo card that are occupied by the daub.

1-5. The gaming system of 1-4, wherein the location characteristic comprises additional spaces on the card that are occupied by the daub.

1-6. The gaming system of 1-4, wherein the location characteristic comprises a row or column wildcard value, the method further comprising receiving an input from the user where to place the daub according to the wildcard value.

1-7. The gaming system according to any one or a combination of one or more of 1-1 to 1-6 above and 1-8 to 1-11 below, wherein the gaming system is further caused present a selection of placement of a daub according to the wildcard value.

1-8. The gaming system according to any one or a combination of one or more of 1-1 to 1-7 above and 1-9 to 1-11 below, wherein the value characteristic comprises whether or not the calls count toward a call limit that defines a winning condition for the Bingo game.

1-9. The gaming system according to any one or a combination of one or more of 1-1 to 1-8 above and 1-4 to 1-11 below, wherein, for each call, the daub is randomly assigned a display characteristic.

1-10. The gaming system according to any one or a combination of one or more of 1-1 to 1-9 above and 1-11 below, wherein, for each call, the daub is randomly assigned a value characteristic.

1-11. The gaming system according to any one or a combination of one or more of 1-1 to 1-10 above, wherein, for each call, the daub is randomly assigned a location characteristic.

1-12. A gaming method comprising:
displaying an output of a Bingo game on a display device;
accepting a wager by an input device for on one or more outcomes of the Bingo game and accepting one or more control inputs pertaining to the Bingo game;
with a processor of a gaming system, executing the following steps:
   presenting a Bingo card having a plurality of spaces in a grid, wherein each space has an associated identifier and a location on the card, wherein the identifiers are assigned at random;
   executing a series of calls, each call including an identifier selected at random and a daub selected at random;
   selecting a daub for each call wherein the daub is displayed on the display device on the card in a space corresponding to the identifier in the call,
      wherein, for each call, the daub is randomly assigned one or more of:
         a display characteristic;
         a value characteristic; or
         a location characteristic;
   identifying a combination of daubs relative to the card that satisfies one or more winning conditions; and
   awarding a payout according to the one or more winning conditions and the wager.

1-13. The method according to any one or a combination of one or more of 1-12 above and 1-14 to 1-22 below, wherein the display characteristic of the daubs comprises one or more of color, movement, and shape displayed on the display device.

1-14. The method according to any one or a combination of one or more of 1-12 to 1-13 above and 1-15 to 1-22 below, wherein the value characteristic comprises a monetary value, and wherein the payout is correlated to the combined value characteristics of the daubs that together satisfy the winning condition for the Bingo game.

1-15. The method according to any one or a combination of one or more of 1-12 to 1-14 above and 1-16 to 1-22 below, wherein the location characteristic comprises a number of spaces on the Bingo card that are occupied by the daub.

1-16. The method according to any one or a combination of one or more of 1-12 to 1-15 above and 1-17 to 1-22 below, wherein the location characteristic comprises additional spaces on the card that are occupied by the daub.

1-17. The method according to any one or a combination of one or more of 1-12 to 1-16 above and 1-18 to 1-22 below, wherein the location characteristic comprises a row or column wildcard value, the method further comprising receiving an input from the user where to place the daub according to the wildcard value.

1-18. The method according to any one or a combination of one or more of 1-12 to 1-17 above and 1-19 to 1-22 below, wherein the gaming system is further caused present a selection of placement of a daub according to the wildcard value.

1-19. The method according to any one or a combination of one or more of 1-12 to 1-18 above and 1-20 to 1-22 below, wherein the value characteristic comprises whether or not the calls count toward a call limit that defines a winning condition for the Bingo game.

1-20. The method according to any one or a combination of one or more of 1-12 to 1-19 above and 1-21 to 1-22 below, wherein, for each call, the daub is randomly assigned a display characteristic.

1-21. The method according to any one or a combination of one or more of 1-12 to 1-20 above and 1-22 below, wherein, for each call, the daub is randomly assigned a value characteristic.

1-22. The method according to any one or a combination of one or more of 1-12 to 1-21 above, wherein, for each call, the daub is randomly assigned a location characteristic.

1-23. A hardware storage device having stored thereon computer executable instructions which, when executed by one or more processors of a gaming system configure the one or more processors to perform the method according to any one or a combination of two or more of 1-12 to 1-22 above.

2-1. A gaming system, comprising:
a display device configured to display an output pertaining to a Bingo game;
an input device configured to accept a wager on one or more outcomes of the Bingo game, and to accept one or more control inputs pertaining to the Bingo game;
a processor; and a memory configured to store instructions that, when executed by the processor, cause the gaming system to execute a method, the method comprising:
   presenting a first Bingo card having a plurality of first spaces in a grid;
   presenting a second Bingo card having a plurality of second spaces in a grid, wherein the first spaces align with the second spaces; and
   executing a series of calls for the first Bingo card, each call including an identifier selected at random pertaining to a first space on the first Bingo card resulting in a first daub placed on the first space, wherein the first daub is applied to a second space on the second Bingo card as a second daub according to one or more predetermined conditions.

2-2. The gaming system according to any one or a combination of one or more of 2-1 and 2-3 to 2-7 below, wherein the predetermined conditions include a selection by a user.

2-3. The gaming system according to any one or a combination of one or more of 2-1 to 2-2 above and 2-4 to 2-7 below, wherein the predetermined conditions include a random chance executed by the processor.

2-4. The gaming system according to any one or a combination of one or more of 2-1 to 2-3 above and 2-5 to 2-7 below, wherein the first Bingo card and second Bingo card are displayed in three dimensions on the display device.

2-5. The gaming system according to any one or a combination of one or more of 2-1 to 2-4 above and 2-6 to 2-7 below, wherein the display device indicates that the first daub and second daub are related.

2-6. The gaming system according to any one or a combination of one or more of 2-1 to 2-5 above and 2-7 below, wherein the selection by the user is made after presenting the user with a diminished payout as a result of the selection.

2-7. The gaming system according to any one or a combination of one or more of 2-1 to 2-6 above, wherein the series of calls pertains to the first Bingo card and/or to the second Bingo card.

2-8. A gaming method comprising:
displaying an output of a Bingo game on a display device;
accepting a wager by an input device for on one or more outcomes of the Bingo game and accepting one or more control inputs pertaining to the Bingo game;
with a processor of a gaming system, executing the following steps:
   presenting a first Bingo card having a plurality of first spaces in a grid;
   presenting a second Bingo card having a plurality of second spaces in a grid, wherein the first spaces align with the second spaces; and
   executing a series of calls for the first Bingo card, each call including an identifier selected at random pertaining to a first space on the first Bingo card resulting in a first daub placed on the first space, wherein the first daub is applied to a second space on the second Bingo card as a second daub according to one or more predetermined conditions.

2-9. The gaming method according to any one or a combination of one or more of 2-8 above and 2-10 to 2-14 below, wherein the predetermined conditions include a selection by a user.

2-10. gaming method according to any one or a combination of one or more of 2-8 to 2-9 above and 2-11 to 2-14 below, wherein the predetermined conditions include a random chance executed by the processor.

2-11. gaming method according to any one or a combination of one or more of 2-8 to 2-10 above and 2-12 to 2-14 below, wherein the first Bingo card and second Bingo card are displayed in three dimensions on the display device.

2-12. The gaming system according to any one or a combination of one or more of 2-8 to 2-11 above and 2-13 to 2-14 below, wherein the display device indicates that the first daub and second daub are related.

2-13. The gaming method according to any one or a combination of one or more of 2-8 to 2-12 above and 2-14 below, wherein the selection by the user is made after presenting the user with a diminished payout as a result of the selection.

2-14. The gaming method according to any one or a combination of one or more of 2-8 to 2-13 above, wherein the series of calls pertains to the first Bingo card and/or to the second Bingo card.

2-15. A hardware storage device having stored thereon computer executable instructions which, when executed by one or more processors of a gaming system configure the one or more processors to perform the method according to any one or a combination of two or more of 2-8 to 2-14 above.

3-1. A gaming system, comprising:
a display device configured to display an output to a user pertaining to a Bingo game;
an input device configured to accept a wager on one or more outcomes of the Bingo game, and to accept one or more control inputs from a user pertaining to the Bingo game;
a processor; and
a memory configured to store instructions that, when executed by the processor, cause the gaming system to execute a method, the method comprising:
   presenting to the user two or more Bingo cards each having a plurality of spaces in a grid, wherein each space has an associated identifier and a location on the card, wherein the identifiers are assigned at random;
      wherein the Bingo cards include first spaces and second spaces visually distinct from the first spaces;
      wherein arranging two or more Bingo cards relative to one another forms an image combining first spaces from one Bingo card and first spaces from a second Bingo card; and
      wherein a winning combination of calls pertains to the image.

3-2. The gaming system of 3-1, further comprising receiving an input from the user to arrange the Bingo cards relative to one another.

3-3. A gaming method comprising:
displaying an output of a Bingo game on a display device;
accepting a wager by an input device for on one or more outcomes of the Bingo game and accepting one or more control inputs pertaining to the Bingo game;
with a processor of a gaming system, executing the following steps:
   presenting to the user two or more Bingo cards each having a plurality of spaces in a grid, wherein each space has an associated identifier and a location on the card, wherein the identifiers are assigned at random;
      wherein the Bingo cards include first spaces and second spaces visually distinct from the first spaces;
      wherein arranging two or more Bingo cards relative to one another forms an image combining first spaces from one Bingo card and first spaces from a second Bingo card; and
      wherein a winning combination of calls pertains to the image.

3-4. The gaming method of 3-3, further comprising receiving an input from the user to arrange the Bingo cards relative to one another.

1. A gaming system, comprising:
a display device configured to display an output pertaining to a Bingo game;
an input device configured to accept a wager on one or more outcomes of the Bingo game, and to accept one or more control inputs pertaining to the Bingo game;
a processor; and
a memory configured to store instructions that, when executed by the processor, cause the gaming system to execute the following steps:
present a Bingo card having a plurality of spaces in a grid, wherein each space has an associated identifier and a location on the card, wherein the identifiers are assigned at random;
execute a series of calls, each call including an identifier selected at random and a daub selected at random;
select a daub for each call wherein the daub is displayed on the display device on the card in a space corresponding to the identifier in the call,
wherein, for each call, the daub is randomly assigned one or more of:
a display characteristic;
a value characteristic; or
a location characteristic;
identify a combination of daubs relative to the card that satisfies one or more winning conditions; and
award a payout according to the one or more winning conditions and the wager.

2. The gaming system of claim 1, wherein the display characteristic of the daubs comprises one or more of color, movement, and shape displayed on the display device.

3. The gaming system of claim 1, wherein the value characteristic comprises a monetary value, and wherein the payout is correlated to the combined value characteristics of the daubs that together satisfy the winning condition for the Bingo game.

4. The gaming system of claim 1, wherein the location characteristic comprises a number of spaces on the Bingo card that are occupied by the daub.

5. The gaming system of claim 4, wherein the location characteristic comprises additional spaces on the card that are occupied by the daub.

6. The gaming system of claim 4, wherein the location characteristic comprises a row or column wildcard value, the method further comprising receiving an input from the user where to place the daub according to the wildcard value.

7. The gaming system of claim 1, wherein the gaming system is further caused present a selection of placement of a daub according to the wildcard value.

8. The gaming system of claim 1, wherein the value characteristic comprises whether or not the calls count toward a call limit that defines a winning condition for the Bingo game.

9. The gaming system of claim 1, wherein, for each call, the daub is randomly assigned a display characteristic.

10. The gaming system of claim 1, wherein, for each call, the daub is randomly assigned a value characteristic.

11. The gaming system of claim 1, wherein, for each call, the daub is randomly assigned a location characteristic.

12. A gaming system, comprising:
a display device configured to display an output pertaining to a Bingo game;
an input device configured to accept a wager on one or more outcomes of the Bingo game, and to accept one or more control inputs pertaining to the Bingo game;
a processor; and
a memory configured to store instructions that, when executed by the processor, cause the gaming system to execute a method, the method comprising:
presenting a first Bingo card having a plurality of first spaces in a grid;
presenting a second Bingo card having a plurality of second spaces in a grid, wherein the first spaces align with the second spaces; and
executing a series of calls for the first Bingo card, each call including an identifier selected at random pertaining to a first space on the first Bingo card resulting in a first daub placed on the first space, wherein the first daub is applied to a second space on the second Bingo card as a second daub according to one or more predetermined conditions.

13. The gaming system of claim 9, wherein the predetermined conditions include a selection by a user.

14. The gaming system of claim 9, wherein the predetermined conditions include a random chance executed by the processor.

15. The gaming system of claim 9, wherein the first Bingo card and second Bingo card are displayed in three dimensions on the display device.

16. The gaming system of claim 12, wherein the display device indicates that the first daub and second daub are related.

17. The gaming system of claim 9, wherein the selection by the user is made after presenting the user with a diminished payout as a result of the selection.

18. The gaming system of claim 9, wherein the series of calls pertains to the first Bingo card and/or to the second Bingo card.

19. A gaming system, comprising:
a display device configured to display an output to a user pertaining to a Bingo game;
an input device configured to accept a wager on one or more outcomes of the Bingo game, and to accept one or more control inputs from a user pertaining to the Bingo game;
a processor; and
a memory configured to store instructions that, when executed by the processor, cause the gaming system to execute a method, the method comprising:
presenting to the user two or more Bingo cards each having a plurality of spaces in a grid, wherein each space has an associated identifier and a location on the card, wherein the identifiers are assigned at random;
wherein the Bingo cards include first spaces and second spaces visually distinct from the first spaces;
wherein arranging two or more Bingo cards relative to one another forms an image combining first spaces from one Bingo card and first spaces from a second Bingo card; and
wherein a winning combination of calls pertains to the image.

20. The gaming system of claim 16, further comprising receiving an input from the user to arrange the Bingo cards relative to one another.
